(19) United States
(12) Patent Application Publication
(10) Pub. No.: US 2009/0188449 A1
(43) Pub. Date: Jul. 30, 2009

(54) METHOD TO ENHANCE AND IMPROVE SOLID CARBONACEOUS FUEL COMBUSTION SYSTEMS USING A HYDROGEN-RICH GAS

(75) Inventor: Timothy FAWCETT, Clearwater, FL (US)

Correspondence Address: DENNIS G. LAPOINTE;LAPOINTE LAW GROUP, PL, PO BOX 1294, TARPON SPRINGS, FL, 34688-1294, US

(73) Assignee: HYDROGEN TECHNOLOGY APPLICATIONS, INC., Clearwater, FL (US)

(21) Appl. No.: 12/354,003

(22) Filed: Jan. 15, 2009

Related U.S. Application Data
(60) Provisional application No. 61/023,145, filed on Jan. 24, 2008.

(51) Int. Cl. F02B 43/12

(52) U.S. Cl. 123/3; 123/575

(57) ABSTRACT

A method for improving the efficiency, enhancing the heat output, and reducing the harmful emissions of a solid carbonaceous fuel combustion system by introducing a hydrogen-rich gas into a solid carbonaceous fuel combustion process at one or more predetermined injection points or directly into a flame of the combustion process where the hydrogen-rich gas is controlled to be introduced at a desired flow-rate. The gas is introduced through one or more predetermined injection points which are selected from one or a combination of one or more primary air streams with the solid carbonaceous fuel prior to combustion, one or more secondary air streams with the solid carbonaceous fuel at combustion, one or more tertiary/overfire air streams downstream of the solid carbonaceous fuel combustion, and one or more injection ports near an exit end of a furnace of said combustion process.

### RELATED APPLICATION

This application claims the benefit of U.S. Provisional Patent Application Ser. No. 61/023,145 filed Jan. 24, 2008.

### FIELD OF THE INVENTION

This invention relates to improvement of the efficiency, enhancing of the heat output, and the reduction of the harmful emissions of solid carbonaceous fuel combustion systems with the use of a unique hydrogen-rich gas.

### BACKGROUND OF THE INVENTION

Several methods to improve the efficiency, enhance the heat output, and reduce the harmful emissions of solid carbonaceous fuel combustion systems are known in the art. Such systems include oxy-fuel combustion methods such as disclosed by Kobayashi et al. in U.S. Pat. No. 6,699,029 and Gross in U.S. Pat. No. 7,282,171, Burhe et al. (“Oxy-Fuel Combustion Technology for Coal-Fired Power Generation,” Progress in Energy And Combustion Science 31 (2005) p. 283-307), and Farzan et al. (“State of the Art of Oxy-Coal Combustion Technology for CO₂ Control from Coal-Fired Boilers,” Paper 1783, Third International Technical Conference on Clean Coal Technologies for Our Future, May 15-17, 2007 in Sardinia, Italy), in which carbonaceous fuels such as coal are combusted in the presence of high purity oxygen (greater than 85%). Such systems generate higher furnace temperatures, consume less fuel to maintain a constant heat output, and reduce nitrogen oxide emissions. However, oxy-fuel combustion systems possess several shortcomings that have yet been addressed in the art. First, all oxy-fuel systems require an oxygen source capable of delivering high purity oxygen (above 85%) in large quantities (greater than 8000 tons per day) in an efficient and cost effective manner. The current state of the art oxygen generation systems are “air separation units,” complex and expensive apparatuses consisting of an air compressor, pre-cooling system, purification unit, heat exchangers, and distillation columns. In addition to requiring a high-purity oxygen source, state of the art oxy-fuel combustion systems require a redesign of the combustion system including the recirculation of flue gases to “control flame temperature and make up for the lost volume of the missing N₂ to ensure there is enough gas to carry the heat through the boiler” (Burhe et al.) and the potential incorporation of new burners such as disclosed by Espedal in U.S. Pat. No. 4,445,444. Thus, although oxy-fuel combustion systems improve the efficiency, enhance the heat output, and reduce the harmful emissions of solid carbonaceous fuel combustion systems, oxy-fuel combustion systems are cost prohibitive and require significant modifications to existing solid carbonaceous fuel combustion systems.

Another method to improve the efficiency, enhance the heat output, and reduce the harmful emissions of solid carbonaceous fuel combustion systems known in the art includes the gasification of solid carbonaceous fuels to produce a synthetic gas, generally consisting of hydrogen (H₂) and carbon monoxide (CO). This synthetic gas is subsequently utilized to produce liquid fuels or combusted in a gas turbine to generate electrical power. Examples of such systems include those disclosed in Calderon et al. in U.S. Pat. No. 6,911,058, Kim in U.S. Pat. No. 6,790,383, and Dowdy in U.S. Pat. No. 5,955,039. Carbonaceous fuel gasification processes generally combine the carbonaceous fuel with oxygen, water, and/or steam in a high temperature environment and produce a synthetic gas which is composed primarily of H₂ and CO. With the synthetic gas being in a vapor state, impurities such as sulfur can be easily removed reducing sulfur oxide (SOₓ) based emissions. However, it is well known in the art that the synthetic gas produced by gasification processes possesses a lower heating value than that of coal and/or other solid, liquid, or gaseous carbonaceous fuels the synthetic gas was derived from. Thus, the gasification of carbonaceous fuels reduces harmful emissions but fails to improve the efficiency and enhance the heat output of solid carbonaceous fuel combustion systems. Also, the current state of the art carbonaceous fuel gasification processes are not economically viable as they require extremely large capital investment and are subject to high operating costs relative to traditional coal-fired combustion systems.

Yet another method to improve the efficiency, enhance the heat output, and reduce the harmful emissions of solid carbonaceous fuel combustion systems known in the art includes the hydrogenation of solid carbonaceous fuels. Examples of such systems include those disclosed in Kindig et al. in U.S. Pat. No. 7,232,472, Sinor in U.S. Pat. No. 4,243,509, Friedman et al. in U.S. Pat. No. 4,206,032, and Jones in U.S. Pat. No. 4,158,637. Solid carbonaceous fuel hydrogenation processes generally consist of reacting a fuel, such as coal, with hydrogen (H₂) and/or methane (CH₄) to produce hydrocarbon gases and liquids which are subsequently either utilized as or converted to gaseous or liquid fuels. The current state of the art solid carbonaceous fuel hydrogenation processes do not directly improve the efficiency, enhance the heat output, and reduce the harmful emissions of solid carbonaceous fuel combustion systems. Hydrogenation processes transform the solid carbonaceous fuels into gaseous and/or liquid fuels, transferring the combustion environment to those suited for the combustion of gaseous and/or liquid fuels. Also, all hydrogenation processes require a source of hydrogenation gas such as H₂ or CH₄. Currently, the primary source of pure H₂ is from natural gas reforming processes, such as disclosed by Kim et al. in U.S. Pat. No. 5,932,181 and/or Lomax et al. in U.S. Pat. No. 6,497,856. However, the carbon in natural gas is emitted to the atmosphere following the reformation process, thus decreasing the reduction in emissions hydrogenation processes may possess.

Yet another method to improve the efficiency, enhance the heat output, and reduce the harmful emissions of solid carbonaceous fuel combustion systems known in the art includes replacing the solid carbonaceous fuel boiler with a hydrogen-fired combustion system. An example of such a system includes the process disclosed by Bannister et al. in U.S. Pat. No. 6,263,568 in which a coal-fired steam boiler is replaced with a hydrogen-fired combustion system directed to a steam turbine system. Although a hydrogen-fired combustion system would theoretically emit zero carbon-based emissions, emissions from the production of H₂ would not be eliminated. A hydrogen-fired combustion system requires a large amount of pure H₂. Currently, the primary source of pure H₂ is from natural gas reforming processes, such as disclosed by Kim et al. in U.S. Pat. No. 5,932,181 and/or Lomax et al. in U.S. Pat. No. 6,497,856. However, the carbon in natural gas is emitted to the atmosphere following the reformation process, thus decreasing the potential reduction in emissions hydrogen-fired combustion system processes may possess. Also, the conversion of a coal-fired steam boiler to a hydrogen-fired combustion system requires a significant capital expenditure, boiler redesign, and possesses many safety concerns including the potential explosion of the high-pressure hydrogen source in the event of a flashback. Thus, although the conversion of coal-fired steam boiler systems to hydrogen-fired combustion systems improves efficiency and enhances the heat output of the baseline coal-fired steam boiler system, the carbon based emissions are not eliminated and the capital expenditure and safety concerns render such hydrogen-fired combustion systems unreasonable alternatives to the current coal-fired steam boiler systems.

Yet another method to improve the efficiency, enhance the heat output, and reduce the harmful emissions of solid carbonaceous fuel combustion systems known in the art includes the electrolysis of said solid carbonaceous fuel. An example of such a system includes the process disclosed by Botte in WO 2006/121981 published Nov. 16, 2006, in which an electrolytic cell for the electro-oxidation of coal in an acidic medium to produce hydrogen (H₂) is disclosed. The current state of the art solid carbonaceous fuel electrolysis processes do not directly improve the efficiency, enhance the heat output, and reduce the harmful emissions of solid carbonaceous fuel combustion systems. Carbonaceous fuel electrolysis processes transform the solid carbonaceous fuels primarily into hydrogen (H₂) transferring the combustion environment to those suited for the combustion of H₂. The carbon in the coal processed through the electro-oxidation process disclosed by Botte is emitted as carbon dioxide (CO₂). Also, the state of the art process disclosed by Botte is currently only 10% efficient at converting coal to H₂, far from the 77% theoretical efficiency. Thus, the Botte coal electrolysis process does not improve efficiency, enhance heat output, or reduce harmful emissions.

Although oxy-fuel combustion systems, gasification and hydrogenation of solid carbonaceous processes, retrofitting of coal-fired steam boilers with hydrogen-fired combustion systems, and coal electrolysis processes have been successfully implemented in test and production facilities, these state of the art processes do not currently meet the need in the art to improve efficiency, enhance heat output, and reduce harmful emissions in a cost effective and easily implemented manner. The present invention improves the efficiency, enhances the heat output, and reduces harmful emissions of solid carbonaceous fuel combustion systems using a unique hydrogen-rich gas in a cost effective and easily implemented manner.

### SUMMARY OF THE INVENTION

This invention is a method for improving the efficiency, enhancing the heat output, and reducing the harmful emissions of solid carbonaceous fuel combustion systems using a unique hydrogen-rich gas.

Generally, the invention is a method in which a hydrogen-rich gas is introduced to a solid carbonaceous fuel combustion process resulting in higher temperatures, greater heat output, and greatly improved emissions when compared to the solid carbonaceous fuel combusted alone. The hydrogen-rich gas is introduced to the solid carbonaceous fuel combustion process through one or more injection points. These injection points include but are not limited to the primary solid carbonaceous fuel/air, secondary, tertiary and overfire air streams, through the end of the furnace, as well as directly into the flame generated through the combustion of the solid carbonaceous fuel. These methods of injection can also be combined in any manner in the same hydrogen-rich gas enhanced solid carbonaceous fuel combustion process to obtain the optimum improvement in efficiency, enhancement of heat output, and reduction of harmful emissions.

The solid carbonaceous fuels contemplated as within the scope of this invention include but are not limited to coal, coke, char, and peat.

The hydrogen-rich gas described in this application can be delivered to the hydrogen-rich gas enhanced solid carbonaceous fuel combustion system from several sources including but not limited to one or more hydrogen-rich gas generating systems, hydrogen-rich gas compressed and/or otherwise stored in a tank or other similar device, and separate components that makeup the hydrogen-rich gas produced and/or delivered to a mixing system. Examples of a hydrogen-rich gas made up of separate components include pure hydrogen mixed with pure oxygen delivered “dry” or bubbled through water and delivered to a solid carbonaceous fuel combustion process. These hydrogen-rich gas sources can also be combined in any manner in the same hydrogen-rich gas enhanced solid carbonaceous fuel combustion process.

In a preferred embodiment, the hydrogen-rich gas is produced from water by one or more hydrogen-rich gas generating system. One example of such a system is that described in U.S. Pat. No. 6,689,259 utilizing one or more electrolyzers similar to those described in U.S. Patent Publication No. 2007/0151846A1, which are both hereby incorporated by reference in their entirety. As noted above, however the hydrogen-rich gas is generated, another source of the gas in the present inventive method is the hydrogen-rich gas having been pre-made and compressed and/or otherwise stored in a tank or other similar device, and separate components that makeup the hydrogen-rich gas produced and/or delivered to a mixing system.

The hydrogen-rich gas described in this invention is generally comprised of hydrogen and oxygen. Hydrogen-rich gases containing species in addition to hydrogen and oxygen, such as water, are contemplated as within the scope of this invention. In a preferred embodiment, the hydrogen-rich gas is generally composed of greater than 50% hydrogen by volume. In another preferred embodiment, the hydrogen-rich gas is produced from water by one or more hydrogen-rich gas generation system, as described above, and is generally composed of 60-70% hydrogen, 30-40% oxygen, 0-5% water, and other compounds containing hydrogen and oxygen atoms.

This improved solid carbonaceous fuel combustion system can be retrofitted to existing or utilized in new solid carbonaceous fuel combustion systems. These improved solid carbonaceous fuel combustion systems will consume less solid carbonaceous fuel as well as greatly reduce the harmful emissions while generating the same amount of heat.

### BRIEF DESCRIPTION OF THE DRAWINGS

In the accompanying drawings,

FIG. 1 is a schematic conceptual representational depiction of the process or method wherein the hydrogen-rich gas is added to a solid carbonaceous fuel combustion system, such as a coal combustion system;

FIG. 2 is a schematic conceptual representation depicting examples of hydrogen-rich gas injection points in a solid carbonaceous fuel combustion system, that is, a solid carbonaceous fuel fired furnace;

FIG. 3 is a representative graph depicting the maximum furnace temperature as a function of the scaled hydrogen-rich gas flow for three different ranks of coal, where the scaled hydrogen-rich gas flow is the total hydrogen-rich gas flow, measured in standard liters per hour (SLPH) divided by the total coal feed rate measured in pounds per hour (lb/h);

FIG. 4 is a representative graph depicting the estimated specific heat generation as a function of the scaled hydrogen-rich gas flow for three different ranks of coal, where the specific heat generation is the measured amount of heat generated (BTU/hr) divided by the coal feed rate (lb/hr) and the scaled hydrogen-rich gas flow is the total hydrogen-rich gas flow, measured in standard liters per hour (SLPH) divided by the total coal feed rate measured in pounds per hour (lb/h); and,

FIG. 5 is a representative graph depicting the maximum furnace temperature as a function of coal feed rate for three different ranks of coal as a specific flow of hydrogen-rich gas is introduced to a solid carbonaceous fuel fired furnace.

### DETAILED DESCRIPTION OF THE INVENTION

As described above, the invention is a method for improving the efficiency, enhancing the heat output, and reducing the harmful emissions of solid carbonaceous fuel combustion systems using a unique hydrogen-rich gas. The solid carbonaceous fuels contemplated as within the scope of this invention include coal, coke, char, and peat. The hydrogen-rich gas described in this application can be delivered to the hydrogen-rich gas enhanced solid carbonaceous fuel combustion system from several sources including but not limited to one or more hydrogen-rich gas generating systems, hydrogen-rich gas compressed and/or otherwise stored in a tank or other similar device, and separate components that makeup the hydrogen-rich gas produced and/or delivered to a mixing system. Examples of a hydrogen-rich gas made up of separate components include pure hydrogen mixed with pure oxygen delivered “dry” or bubbled through water and delivered to a solid carbonaceous fuel combustion process. These hydrogen-rich gas sources can also be combined in any manner in the same hydrogen-rich gas enhanced solid carbonaceous fuel combustion process to obtain the optimum improvement in efficiency, enhancement of heat output, and reduction of harmful emissions.

In a preferred embodiment, the hydrogen-rich gas is produced from water by one or more hydrogen-rich gas generating system. One example of such a system is that described in U.S. Pat. No. 6,689,259 utilizing one or more electrolyzers similar to those described in U.S. Patent Publication No. 2007/0151846A1, both of which are hereby incorporated by reference in their entirety.

The hydrogen-rich gas described in this invention is generally comprised of hydrogen and oxygen. Hydrogen-rich gases containing species in addition to hydrogen and oxygen, such as water, are contemplated as within the scope of this invention. In a preferred embodiment, the hydrogen-rich gas is generally composed of greater than 50% hydrogen by volume. In another preferred embodiment, the hydrogen-rich gas is produced from water by one or more hydrogen-rich gas generation system, as described above, and is generally composed of 60-70% hydrogen, 30-40% oxygen, 0-5% water, and other compounds containing hydrogen and oxygen atoms.

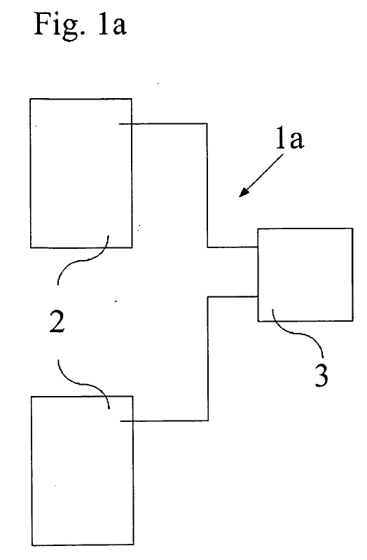

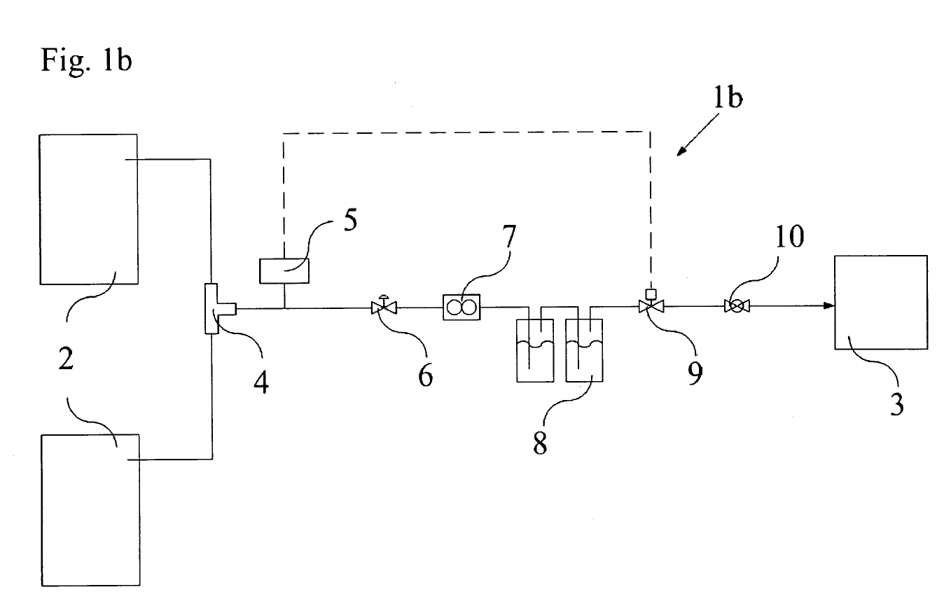

With reference to FIG. 1a, an example of an arrangement of components/systems that will enable the present inventive process or method is a hydrogen-rich gas enhanced solid carbonaceous fuel combustion system 1a that includes one or more hydrogen-rich gas sources 2 fluidly connected to one or more solid carbonaceous fuel combustion processes 3.

With reference to FIG. 1b, an example of an arrangement of components/systems that will enable a preferred embodiment of the present inventive process or method is a hydrogen-rich gas enhanced solid carbonaceous fuel combustion system 1b that includes one or more hydrogen-rich gas sources 2, a gas manifold system 4, a pressure switch 5, a pressure regulator 6, a flow controller 7, one or more water-safety devices 8, a solenoid valve 9, a ball valve 10 and one or more solid carbonaceous fuel combustion processes 3. One or more hydrogen-rich gas sources 2 are fluidly connected to the inlet(s) of a gas manifold system 4 which combine the hydrogen-rich gas supplied from one or more hydrogen-rich gas sources 2. The hydrogen-rich gas sources 2 considered within the scope of this invention include but are not limited to one or more hydrogen-rich gas generating systems, hydrogen-rich gas compressed and/or otherwise stored in a tank or other similar device, and separate components that makeup the hydrogen-rich gas produced and/or delivered to a mixing system. These hydrogen-rich gas sources can also be combined in any manner in the same hydrogen-rich gas enhanced solid carbonaceous fuel combustion process. In a preferred embodiment, the one or more hydrogen-rich sources 2 are comprised of one or more hydrogen-rich gas generating systems, which produce the hydrogen-rich gas from water as described in the aforementioned patent and patent publication.

The outlet of the gas manifold system 4 is fluidly connected to a pressure switch 5 as well as a pressure regulator 6. The pressure switch 5 is in electrical contact with a solenoid valve 9 in order to close the solenoid valve 9 when the pressure delivered from the one or more hydrogen-rich gas sources 2 is below a pre-defined value to decrease the risk of flashbacks reaching the one or more hydrogen-rich gas sources 2 due to low pressure conditions. The pressure regulator 6 is used to regulate the delivery pressure of hydrogen-rich gas from one or more hydrogen-rich sources 2 to the hydrogen-rich gas enhanced solid carbonaceous fuel combustion process 3.

The pressure regulator 6 is fluidly connected to a flow controller 7 which is used to control the flow of hydrogen-rich gas to one or more solid carbonaceous fuel combustion processes 3 at a desired rate. The flow controller 7 is fluidly connected to one or more water-safety devices 8 which are a preferred method to prevent potential flashbacks from reaching the one or more hydrogen-rich gas sources 2. The one or more water-safety devices 8 are in fluid contact with a solenoid valve 9 which is closed when the electrical signal from the pressure switch 5 senses the pressure delivered from the one or more hydrogen-rich gas sources is below a pre-defined value. The solenoid valve 9 is fluidly connected with a ball valve 10 which when open subjects the solid carbonaceous fuel combustion process 3 to hydrogen-rich gas and not when closed. The ball valve 10 is fluidly connected to one or more solid carbonaceous fuel combustion processes 3.

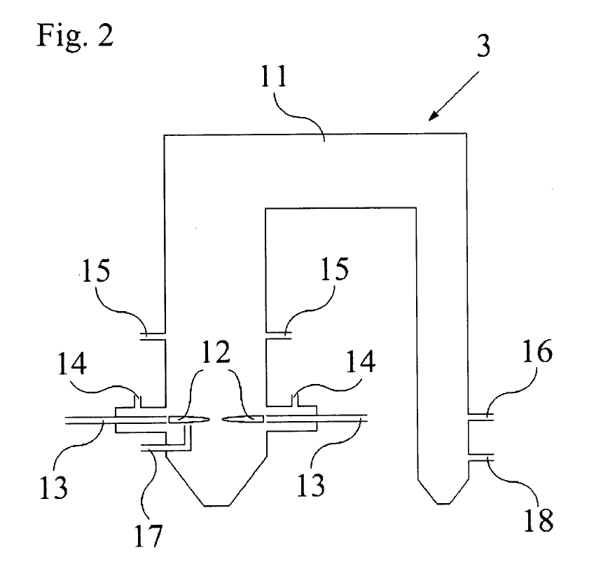

With reference to FIG. 2, an example hydrogen-rich gas enhanced solid carbonaceous fuel combustion system 3 comprises a furnace 11, one or more solid carbonaceous fuel fired flames 12, one or more primary air/ solid carbonaceous fuel streams 13, one or more secondary air streams 14, one or more tertiary and/or overfire air streams 15, one or more injection ports 16 near the end of the furnace 11, one or more injection ports 17 directed into one or more solid carbonaceous fuel fired flames 12, and one or more exit ports 18. Within a furnace 11, solid carbonaceous fuel is combusted with air, hydrogen-rich gas or a combination thereof to produce a flame 12. Solid carbonaceous fuel and air, hydrogen-rich gas or a combination thereof is supplied to the hydrogen-rich gas enhanced solid carbonaceous fuel combustion process through the one or more primary air/solid carbonaceous fuel streams 13. Additional air, hydrogen-rich gas or a combination thereof required for solid carbonaceous fuel combustion is optionally supplied through the one or more secondary air streams 14. Additional air, hydrogen-rich gas or a combination thereof is optionally supplied to the solid carbonaceous fuel combustion process through the one or more tertiary and/or overfire air stream(s) 15. Additional air, hydrogen-rich gas or a combination thereof is optionally supplied through one or more injection ports 16 near the end of the furnace 11. Additional air, hydrogen-rich gas or a combination thereof is optionally supplied through one or more injection ports 17 directed into the solid carbonaceous fuel fired flame 12. All flue gases exit the furnace 11 though the exit port 18.

It is understood that the methods of injection include but are not limited to through the one or more primary air/solid carbonaceous fuel streams 13, one or more secondary streams 14, one or more tertiary and overfire air streams 15, one or more injection ports 16 near the end of the furnace 11, and one or more injection ports 17 directly into one or more solid carbonaceous fuel fired flames 12 and these methods of injection can also be combined in any manner in the same hydrogen-rich gas enhanced solid carbonaceous fuel combustion system 3. In the following examples, the method of the invention will be further revealed, in which coal was used as the solid carbonaceous fuel.

### EXAMPLE 1

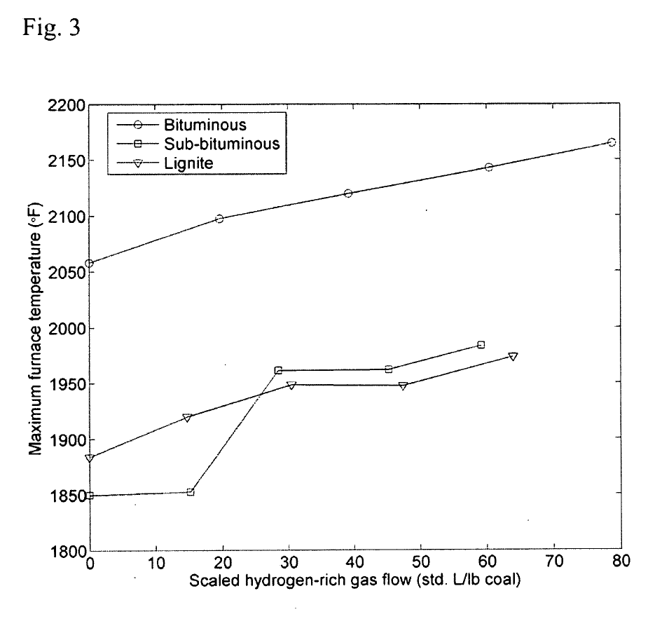

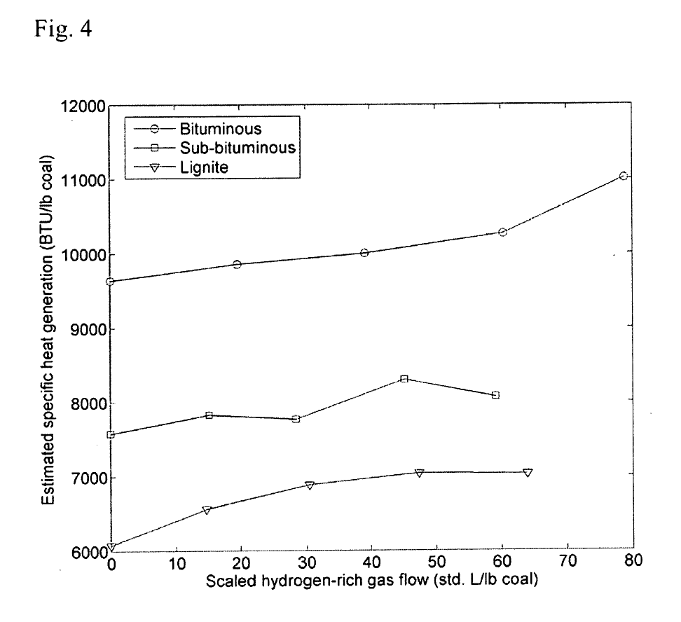

With reference to FIG. 2, hydrogen-rich gas was injected into the hydrogen-rich gas enhanced solid carbonaceous fuel combustion process through both the primary streams 13 and the secondary streams 14 with bituminous coal as the sole solid carbonaceous fuel. As a result, the maximum furnace temperature increased by about 5%, the specific heat generation increased by about 14%, and the fly-ash particle size increased by about 30%. Plots showing the maximum furnace temperature and specific heat generation as a function of scaled hydrogen-rich gas flow for bituminous coal are given in FIG. 3 and FIG. 4, respectively.

### EXAMPLE 2

With reference to FIG. 2, hydrogen-rich gas was injected into the hydrogen-rich gas enhanced solid carbonaceous fuel combustion process through both the primary streams 13 and the secondary streams 14 with sub-bituminous coal as the sole solid carbonaceous fuel. As a result, the maximum furnace temperature increased by about 7%, the specific heat generation increased by about 10%, and the fly-ash particle size increased by about 15.5%. Plots showing the maximum furnace temperature and specific heat generation as a function of scaled hydrogen-rich gas flow for sub-bituminous coal are given in FIG. 3 and FIG. 4, respectively.

### EXAMPLE 3

With reference to FIG. 2, hydrogen-rich gas was injected into the hydrogen-rich gas enhanced solid carbonaceous fuel combustion process through both the primary streams 13 and the secondary streams 14 with lignite coal as the sole solid carbonaceous fuel. As a result, the maximum furnace temperature increased by about 5%, the specific heat generation increased by about 16%, and the fly-ash particle size increased by about 19%. Plots showing the maximum furnace temperature and specific heat generation as a function of scaled hydrogen-rich gas flow for lignite coal are given in FIG. 3 and FIG. 4, respectively.

### EXAMPLE 4

With reference to FIG. 2, hydrogen-rich gas was injected into the hydrogen-rich gas enhanced solid carbonaceous fuel combustion process through port(s) 16 near the end of the furnace 12 with bituminous coal as the sole solid carbonaceous fuel. As a result, the maximum furnace temperature increased by about 1% and the NOₓ emissions decreased by about 1%.

### EXAMPLE 5

With reference to FIG. 2, hydrogen-rich gas was injected into the hydrogen-rich gas enhanced solid carbonaceous fuel combustion process through the injection ports 17 directed into the solid carbonaceous fuel fired flame 12 with bituminous coal as the sole solid carbonaceous fuel. As a result, the specific heat generation increased by about 2.5%, the maximum furnace temperature increased by about 2.5% and the NOₓ emissions reduced by about 6%.

### EXAMPLE 6

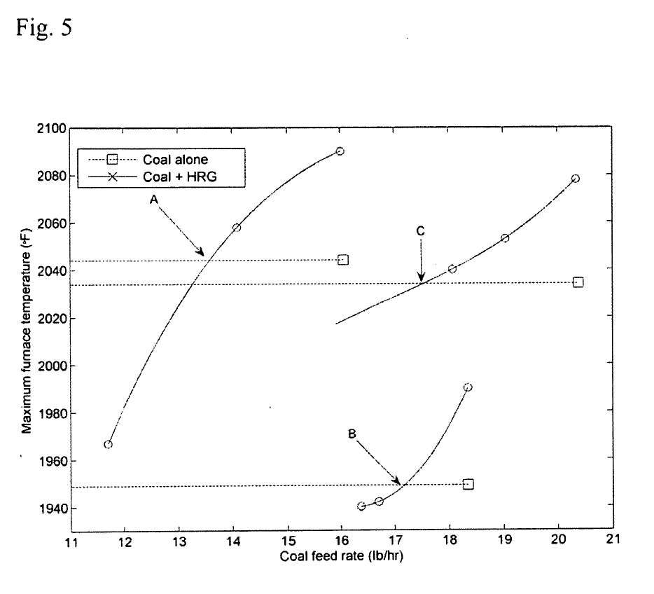

With reference to FIG. 2 and FIG. 5, hydrogen-rich gas was injected into the hydrogen-rich gas enhanced solid carbonaceous fuel combustion process through both the primary streams 13 and the secondary streams 14 with bituminous coal A, sub-bituminous coal B, or lignite coal C as the sole solid carbonaceous fuels.

As a result, the bituminous coal A feed rate was reduced by about 15% from about 16.06 lb/hr to about 13.58 lb/hr with the addition of about 1,260 standard liters per hour (SLPH) of hydrogen-rich gas (HRG) to maintain the same maximum furnace temperature when running on coal alone. In addition to decreasing the coal feed rate by about 15%, sulfur oxide (SOₓ), nitrogen oxide (NOₓ) and carbon monoxide (CO) emissions also decreased by about 15%, 15%, and 29% respectively.

An additional result shows the sub-bituminous coal B feed rate was reduced by about % from about 18.76 lb/hr to about 17.18 lb/hr with the addition of about 945 standard liters per hour (SLPH) of hydrogen-rich gas (HRG) to maintain the same maximum furnace temperature when running on coal alone. In addition to decreasing the coal feed rate by about 8%, sulfur oxide (SOₓ) and carbon monoxide (CO) emissions also decreased by about 28% and 52% respectively.

Yet another result shows the lignite coal C feed rate was reduced by about 14% from about 20.38 lb/hr to about 17.53 lb/hr with the addition of about 945 standard liters per hour (SLPH) of hydrogen-rich gas (HRG) to maintain the same maximum furnace temperature when running on coal alone. In addition to decreasing the coal feed rate by about 15%, sulfur oxide (SOₓ), nitrogen oxide (NOₓ) and carbon monoxide (CO) emissions also decreased by about 15%, 18%, and 89% respectively.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

1. A method for improving the efficiency, enhancing the heat output, and reducing the harmful emissions of solid carbonaceous fuel combustion systems comprising:
introducing a hydrogen-rich gas to a solid carbonaceous fuel combustion process at one or more predetermined injection points or directly into a flame of said combustion process or at a combination of said injection points and said flame, wherein said hydrogen-rich gas is controlled to be introduced at a desired flow-rate.

2. The method according to claim 1, wherein said one or more predetermined injection points are selected from one or a combination of one or more primary air streams with the solid carbonaceous fuel prior to combustion, one or more secondary air streams with said solid carbonaceous fuel at combustion, one or more tertiary/overfire air streams downstream of the solid carbonaceous fuel combustion, and one or more injection ports near an exit end of a furnace of said combustion process.

3. The method according to claim 1, wherein a source of said hydrogen-rich gas is selected from one or a combination of one or more hydrogen-rich gas generator systems, stored pre-generated hydrogen-rich gas, and separate components that makeup the hydrogen-rich gas produced and/or delivered to a mixing system or a combination thereof.

4. The method according to claim 3, wherein said one or more hydrogen-rich gas generator systems comprise in part one or more electrolyzers.

5. The method according to claim 3, wherein water is used as source for generating said hydrogen-rich gas.
